(19) United States
(12) Patent Application Publication
(10) Pub. No.: US 2014/0239164 A1
(43) Pub. Date: Aug. 28, 2014

(54) SYSTEMS AND METHODS FOR MONITORING MATERIALS

(71) Applicant: Research Triangle Institute, Research Triangle Park, NC (US)

(72) Inventors: Ginger D. Rothrock, Cary, NC (US); Mark W. Roberson, Cary, NC (US); Vijay Gupta, Cary, NC (US); Michele L. Ostraat, Somerville, MA (US); David F. Myers, Cary, NC (US)

(73) Assignee: Research Triangle Institute, Research Triangle Park, NC (US)

(21) Appl. No.: 14/191,032

(22) Filed: Feb. 26, 2014

Related U.S. Application Data
(60) Provisional application No. 61/769,885, filed on Feb. 27, 2013.

(51) Int. Cl. G01N 21/59

(52) U.S. Cl. CPC G01N 21/59
USPC 250/227.11

(57) ABSTRACT

The present disclosure provides sensing systems and methods that are useful for monitoring materials (e.g., cement) via light diffusion to identify characteristics thereof and changes therein. The systems can utilize a light source, a light sensor, and light transmitting members combined with the material to be monitored. In use, light from the light source can be allowed to scatter through the material via the light transmitting members for detection by the light sensor. The data regarding the light transfer can be transmitted utilizing a communication interface and can be analyzed using data processing equipment. The systems and methods may particularly be utilized in monitoring the reinforcing cement positioned between the casing and the formation in an oil well.

### CROSS-REFERENCE TO RELATED APPLICATIONS

The present application claims priority to U.S. Provisional Patent Application No. 61/769,885, filed Feb. 27, 2013, the disclosure of which is incorporated herein by reference in its entirety.

### FIELD OF THE DISCLOSURE

The present disclosure relates to systems and methods for monitoring characteristics of materials. More particularly, the present disclosure provides systems and methods for monitoring the integrity of bulk, cast materials, such as cement.

### BACKGROUND

Cement is used as a bulk structural component in many industries. For example, in the petroleum industry, cement is used in barrier systems to provide zonal isolation so as to prevent fluid (liquid or gas) flow between geologic strata, to the surface, and from the penetrated permeable zone. The cement placement, chemical and mechanical properties, adhesion properties, and stresses from the wellbore all can play critical roles in ensuring barrier performance. Current technologies for measuring the reliability of cement and wellbore properties, including well logging and fiber optic cables, have a gap with the requirements for well integrity measurements in terms of the resolution or types information necessary to identify zonal isolation failures throughout the life of a well.

Similarly, other structures utilizing bulk cement can benefit from improved monitoring techniques. For example, cement in buildings, tunnels, roadways, bridges, and the like may have limited access to visual inspections to ensure structural integrity. As such, there is a need in the art for improved systems and methods for monitoring various characteristics of bulk materials, particularly cementitious materials.

### SUMMARY OF THE DISCLOSURE

The present disclosure provides systems and methods that are useful in monitoring various characteristics of materials, particularly in settings where personal, visual inspection may not be easily performed. In particular, the materials to be monitored can be bulk materials, including structural materials, and can be materials that are typically formulated in a liquid or other flowing state and that later harden. One example of a material that can be monitored using the presently disclosed systems and methods is cement. In particular, cement that has been cast, such as in a well surrounding the casing through which petroleum products are produced, can be monitored according to the present disclosure.

The characteristics of a cement matrix (particularly matrix integrity) can be enhanced through use of glass fibers in the wet cement as the fibers can reduce shrinkage-induced cracking. The fibers can provide flexural strength, toughness, and ductility to the cement matrix. As provided according to the present disclosure, waveguiding fibers (e.g., glass fibers) can be coupled with a sensor/monitoring system and method that utilizes light diffusion to alert operators of failures to the material due to, for example, cracking, gas or liquid leakage, or other characteristics of interest. By making use of multiple scattering sites, light diffusion can be used to monitor seemingly opaque materials, such as cementitious materials. By introducing preferential scattering, such as doped optical fiber segments, the presently disclosed systems and methods provide the ability to create controlled distributions of light as well as spectral tags that can provide for monitoring of failures in the bulk material. With the use of narrow band absorption materials (e.g., rare earth compounds), the present disclosure provides for the creation of distinct tag signatures. Still further, when using fibers as described herein, it is possible to functionalize the surface of fibers so as to be sensitive to specific compounds, and this can function as an unambiguous indicator of leaked materials, imminent structure failure, and the presence of tracer materials. By using different wavelengths of light, it further is possible to monitor different physical properties of the bulk material.

Fibers for use in the compositions of the present disclosure can include glass fibers, optical fibers, and/or any further material that can be formed into fibers and that exhibit light scattering and/or waveguiding characteristics. The fibers can be doped or surface-functionalized to alter the scattering characteristics of the fibers and/or to make the fibers more sensitive to a specific wavelength of light. The fibers or the composition generally can further include fluorescent tags or other sensor tags that can aggregate at specific locations in the bulk material and serve to sense material properties at the specific locations.

In one embodiment, Light Diffusion Fracture Tomography (“LDFT”) can utilize visible light in a borehole as a probe of fracture morphology. It also is possible according to the present disclosure to used modified commercial Light Emitting Diodes (“LEDs”) and laser diodes along with sensitive photodiodes and photomultiplier tubes to probe multiple facets. For example, such systems and methods can be used to determine the geometry of fissures and openings prior to cementing, explore and use fluorescent tags, which can preferentially aggregate at the boundaries between the rock and fluids, and monitor the integrity of the cement job once placed and then monitor the signal over time to alert of changes (e.g., fractures) that can be occurring as the well ages. The systems and methods of the present disclosure particularly can include time-resolved and steady state dynamics, co-located and separated source(s) and sensor(s), and optical tomographic reconstruction techniques. Because the light moving through a plurality of optical fibers within a bulk material can scatter multiple times, the interpretation of the geometry can be problematic and has traditionally been difficult to quantify in other systems. According to the present disclosure, however, various optical diffusion reconstruction techniques can be used to analyze data received from the sensors.

In particular embodiments, a system for monitoring a characteristic of a material as provided according to the present disclosure can comprise: a plurality of light transmitting members adapted for intermixture with the material; a light source; a light sensor; and a communication interface. More particularly, the material to be monitored can be a cast material and specifically can be a cementitious material. The light transmitting members can comprise fibers and can particularly be glass fibers, polymeric fibers, and/or optical fibers. Preferably, the light transmitting members are light diffusive and thus are adapted to scatter at least a portion of the incident light. The light source can comprise solid state lighting, such as a light emitting diode or a laser. The light sensor can comprise a photodetector or other suitable detector of electromagnetic radiation. The communication interface can comprise a continuous fiber optic cable. In other embodiments, the communication interface can comprise a wired or wireless communication network, communication through an interface to a tool, and other communication systems recognized as useful by one of skill in the art based on knowledge of the present disclosure. The system of the present disclosure further can comprise a data processing unit. In specific embodiments, the disclosed system can comprise a plurality of light sensors, a plurality of light sources, a plurality of communication interfaces, and any combination thereof. Particularly, at least the light sensors and light sources can be provided in a defined array. In specific embodiments, the light sensor and light source can be characterized as being co-located and separated.

In certain embodiments, the material to be monitored can comprise cement that is filled in at least a portion of an annular space between a casing and a formation wall in a well (e.g., an oil or natural gas well). In such embodiments, one or both of the light source and the light sensor can be attached to the casing adjacent the cement. In alternative embodiments, one or both of the light source and the light sensor can be combined with the material to be monitored.

In some embodiments, one or more components of the disclosed system can be modified to provide alternative functionalities. For example, at least a portion of the light transmitting members can be surface functionalized. Likewise, at least a portion of the light transmitting members can include a doping agent. In other embodiments, the material to be monitored can itself include a doping agent. In either case, the doping agent can particularly be adapted to enhance a light diffusion property of the light transmitting members and/or the material to be monitored. In further embodiments, at least a portion of the light transmitting members can be hollow. Beneficially, at least a portion of the hollow light transmitting members can include a fluid component therein. For example, the fluid component can comprise one or more compounds that are beneficial for self-repair of the material—e.g., sealing cracks or fissures that occur in the material.

The present disclosure also provides methods for monitoring a characteristic of a material. In certain embodiments, a method according to the present disclosure can comprise positioning together the following: a mixture of the material to be monitored and a plurality of light transmitting members; a light source; a light sensor; and a communication interface. Such methods further can comprise receiving data related to light transmission through the plurality of light transmitting members and detection by the light sensor. The received data can be indicative of the characteristic of the material to be monitored. Any of the characteristics of the system disclosed herein can be utilized in implementing the methods of the disclosure. In particular embodiments, the positioning step can comprise filling at least a portion of an annular space between a casing and a formation wall in a well with a mixture of a cementitious material and a plurality of light transmitting members. The positioning step further can comprise locating one or both of the light source and the light sensor on the casing adjacent the mixture of the cementitious material and the plurality of light transmitting members. In particular embodiments, the light source and the light sensor can be in direct communication. For example, such direct communication can be via a continuous fiber optic cable. In other embodiments, the receiving step can comprise comparing transmission of light along a first pathway from the light source to the light sensor through the continuous fiber optic cable and along a second pathway from the light source to the light sensor through the mixture of the cementitious material and the plurality of light transmitting members. In other embodiments, the receiving step can comprise evaluating data received via the fiber optic cable and/or via a wired or wireless communication network.

### BRIEF DESCRIPTION OF THE FIGURES

FIG. 1 is an illustration of a section of a well in a formation as well as a detailed portion thereof showing steel casing surrounded by cement and components of a monitoring system according to a example embodiment of the present disclosure; and

FIG. 2 is an illustration of a section of a well in a formation showing representative photon paths through a fiber optic cable and separately through light transmitting members in cement surrounding the casing according to an example embodiment of the present disclosure.

### DETAILED DESCRIPTION OF THE DISCLOSURE

The invention now will be described more fully hereinafter through reference to various embodiments. These embodiments are provided so that this disclosure will be thorough and complete, and will fully convey the scope of the invention to those skilled in the art. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The present disclosure provides systems and methods for monitoring various characteristics of materials. In particular, bulk materials can include large volumes of material that are not easily amenable to visual evaluation. For example, structural materials, such as concrete, can exhibit a wide range of failures that may be present internal to the material but are not easily identifiable via external means. This problem can be further increased when the bulk materials are in a closed environment, such as below ground (e.g., reinforcing a subterranean structure, such as a wellbore or a tunnel) or internal to an above ground structure, such as a building, roadway, industrial structure, or the like.

The present disclosure addresses these problems by providing systems and methods that can be used to monitor characteristics of materials used in various structures, even in environments where personal, visual evaluation is not possible. The systems and methods of the present disclosure may be exemplified herein in relation to certain embodiments to illustrate the usefulness of the systems and methods. The systems and methods of the present disclosure are not intended to be limited to the exemplified embodiments but will be recognized by the skilled artisan as being applicable to a wide range of further uses. Such recognition is expected to arise from knowledge of the present disclosure, including the specifically exemplified embodiments, as well as the further disclosure herein in relation to the applicability of the disclosed systems and methods to even further embodiments.

As one example of the application of the present disclosure to monitoring characteristics of materials, the systems and methods described herein can be utilized for monitoring cementitious materials, particularly after the cementitious material has been cast and hardened. In specific embodiments, the characteristics of cement utilized in a wellbore or the like can be monitored.

In typical well drilling operations, particularly in the petroleum industry, metal casings are used to line the interior of the well and protect non petroleum zones from produced petroleum products. Once the casing has been placed in the well, it usually is cemented in place. The cement can be pumped down the casing to the bottom of the well and then back up through the free annular space between the casing and the walls of the drilled well. The cement thus serves to bond the casing to the rock formations, prevent fluids from moving from one formation to another, and provide zonal isolation. The properties of the hydrated cement system can determine the quality of the cementing operation. Failures often occur due to chemical shrinkage during hydration, and this can induce cracking or de-bonding between the cement and the casing and/or between the cement and the formation. Some of these failures can be identified immediately following a cement job, during cement bond logging, or during a pressure test; however, these tests do not adequately detect stresses that lead to failures at a later time, and they do not provide resolution necessary to ensure well integrity. Failure can also occur over longer periods of time. As non-limiting examples, failures can arise from stresses or small fissures formed during hydration, the presence of mudcake which diminishes cement integrity, and long term stresses that occur during production, amongst others.

Such failures and further characteristics of cement and other types of materials can be monitored though utilization of the various systems and methods provided according to the present disclosure. The presently disclosed systems for monitoring one or more characteristics of a material can be particularly useful in that they can comprise a plurality of waveguiding members that are adapted for intermixture with the material to be monitored. As more fully discussed below, the waveguiding members can include a variety of articles that can be useful to facilitate movement of electromagnetic radiation through the material to be monitored. In particular embodiments, the waveguiding members can be characterized as light transmitting members that are adapted for intermixture with the material to be monitored. Preferably, the light transmitting members are combined with the material in a manner such that, when in a solid state, the material has the light transmitting members distributed throughout the area of the material that is to be monitored. Such distribution preferably is a homogeneous distribution. Moreover, it can be preferable for the light transmitting members to be distributed in a manner such that some of the light transmitting members are present at an interface of the material with one or more further components of the disclosed system. In the exemplary embodiment of cement used in a well, the light transmitting members can be mixed with the cement such that the admixture is formed during pumping or has already been formed at the time of pumping of the cement in place.

The light transmitting members can comprise any material that is useful for facilitating transmission of light, particularly in a substance having a high opacity (and thus a low transmittance). For example, particles of glass or a similar material can be used. Such particles can be uniformly shaped and dimensioned or can be variably shaped and sized. The light transmitting members particularly can be fibrous. Specifically, staple fibers comprising a light transmitting material can be used. In some embodiments, useful fibers can be made of glass or can be polymeric. In some embodiments, the fibers can be characterized as being optical fibers. Useful fibers can vary in length and diameter. The length can be about 0.1 cm to about 5 cm, about 0.2 cm to about 3 cm, or about 0.2 cm to about 2 cm in length, in some embodiments. The fiber diameter can be about 0.001 mm to about 5 mm, about 0.01 mm to about 3 mm, or about 0.05 mm to about 1 mm.

The light transmitting member generally can be formed of any material that provides the requisite light transmission. Thus, the present disclosure encompasses light transmitting members that provide one or both of direct transmittance and diffuse transmittance. Direct transmittance is understood to relate to light that passes through the light transmitting member with any substantial scattering or diffusion. Diffuse transmittance is understood to relate to light that is scattered or diffused by the light transmitting member. Thus, the light transmitting members can be largely characterized as being light diffusive. The relative scattering or diffusion can be controlled according to the present disclosure not only through choice of material from which the light transmitting members are made but also through specific alterations of the light transmitting members. For example, light transmitting members can be shaped or doped to introduce preferential scattering sites, which can be useful to create controlled distributions of light. Evaluation of the relative change in scattering over time can enable the sensing of a potentially adverse event (e.g. fissure, de-bonding, or presence of fluid). Introduction of preferential scattering sites on the light transmitting members also can be used to form spectral tags that can be useful to identify defined materials or conditions based upon the nature of the light source. As an example, narrow band absorption materials (e.g., rare earth compounds) can be used as dopants to create distinct tag signatures. Beneficially, doped light transmitting members can be added to a material in a specific location so that different manners of monitoring can be facilitated at specific locations. For example, in relation to cementing an oil well, the doped light transmitting members can be added to the flowing cement at a specific pumping stage so that the doped area of the cement can be provided at a calculated depth in the well. Light transmitting members also can be surface functionalized for facilitating doping or for making the light transmitting members sensitive to specific compounds. Such functionalized members can then act as indicators of the presence of the specific compounds being present in the material, either purposefully (e.g., through monitoring of cement hydration) or through a failure of the material that allows entry of foreign materials (e.g., hydrocarbons leaking through the cement).

Similar benefits can be achieved through addition of specific items to the material that is to be monitored. For example, fluorescent tags or other types of tags that are sensitive to hydrocarbons or water can be added to cement that is used in a well such that present monitoring system can identify leaking of such compounds into the cement, which can be indicative of fractures in the cement. Fluorescent tags in particular can provide a spectrally selective increase in light transmission when activated through contact with the compounds to which they are sensitive. Other types of taggants can be identified and utilized based upon the specific compounds that are desired to be identified. As with the light transmitting members, narrow band absorption materials can be added to the material to be monitored.

The present system further can be beneficial to probe the temperature within the material being monitored. For example, thermally sensitive materials can be added to the material to be monitored (or to light transmitting members added thereto), and such thermally sensitive materials can function to change path length of the light through the material being monitored in response to changes in temperature of the material being monitored. The altered path length can then be used to calculate corresponding temperature changes. Similarly, metamaterials having highly sensitive temperature responses can be added to the material to be monitored, and the metamaterials can function to shift light wavelength in response to temperature changes in the material being monitored.

In other embodiments, utilization of other fiber types can provide even further advantages. For example, cladded fibers or hollow fibers filled with hardening agents can provide additional benefits in sensing and/or self-healing systems. Such additives can be tailored for use in a wide variety of bulk materials, particularly cements, as well as epoxy systems, foamed cements, and polymer-cement combinations. Hollow fibers, (e.g., hollow glass fibers) containing liquid healing agents (for example, fibers carrying a liquid epoxy monomer and a corresponding and isolated liquid hardener) can be embedded within the fiber-reinforced cement matrix. When impacted by a crack or other stress, the hollow fiber can rupture and thus fill the resulting porous network with monomer and hardening agent, resulting in a self-repairing system. Such healing fibers can be formed so as to be adapted to survive initial placement of the bulk material (e.g., pumping of the fiber-reinforced cement as described above). Since short fibers tend to align with a laminar flow, such aligned fibers can be easily fractured by stress that occurs perpendicular to the casing in a well.

If desired, the material to be monitored can be modified with a variety of additives. Preferably, any additives to the material to be monitored do not interfere with the light transmission through the light transmitting material. As such, the systems and methods of the present disclosure can provide for a variety of compositions used in the formation of the material to be monitored. For example, in relation to embodiments where the material to be monitored is a cementitious composition, the compositions can consist mainly of a material that is useful to harden upon set. As used herein, the term cement or cementitious material can be defined as a hydraulic binder, latent hydraulic binders or pozzolan, and mixtures thereof. Hydraulic binders can be defined as materials that set and harden in the presence of water. Suitable non-limiting examples of hydraulic binders include Portland cement, masonry cement, alumina cement, refractory cement, magnesia cements (such as a magnesium phosphate cement), magnesium potassium phosphate cement, calcium aluminate cement, calcium sulfoaluminate cement, oil well cement, blended slag, fly ash or pozzolan cement, natural cement, kiln dust, hydraulic hydrated lime, and combinations thereof. Latent hydraulic binders include natural pozzolans, fly ash, blast furnace slag, silica fume, and combinations thereof. The compositions also can comprise viscosity modifying agents, set-retarders, set-accelerators, or other admixture components, such as fluid loss additives, weighting agents, rheology modifiers, cement hydration control agents, shrinkage reducing admixtures, latex, polymeric additives, and combinations thereof.

The system and methods according to the present disclosure further can encompass one or more light sources. A light source can be positioned at an interface with the material that is being monitored so as to emit light that can be transmitted (including diffused) by the light transmitting members present in the material being monitored. In some embodiments, a light source can be positioned within the material being monitored. A light source is not limited to a device that provides visible light. Rather, the light source can be a device that provides any useful spectra of electromagnetic radiation. Such can include all or a part of the visible light spectrum, all or part of the infrared spectrum, all or part of the ultraviolet spectrum, and even electromagnetic radiation of a wavelength or a wavelength range that is outside of the above ranges. If desired, electromagnetic radiation of a single wavelength or a narrow wavelength band, such as a laser, can be used. Laser diodes in particular can be used. In other embodiments, solid state lighting, including semiconductor light emitting diodes (LEDs), organic light emitting diodes (OLEDs), and polymer light emitting diodes (PLEDs). Such solid state lighting can provide electromagnetic radiation in any of the above discussed spectral ranges. In further embodiments, even other types of light emitters can be used, including electrical filaments, plasma (e.g., arc lamps or fluorescent lamps), and gas. In some embodiments, the light source can be used in the absence of the light transmitting members, as the cementitious composition can innately provide the necessary scattering.

Light sensors used in the present systems and methods can include devices adapted for sensing or detecting electromagnetic radiation that is emitted by the light source and transmitted by the light transmitting members through the material being monitored. In certain embodiments, photodetectors can be used. For example, the systems and methods of the disclosure can include: photoresistors or light dependent resistors (LDR); photodiodes (including photovoltaic devices and photoconductive devices); photomultiplier tubes; phototubes; phototransistors; and quantum dot photoconductors or photodiodes. In other embodiments, LEDs that are reverse-biased to act as photodiodes can be used. Of course, the foregoing is only meant to be exemplary of the types of light detectors than can be used.

In addition to the foregoing, the systems and methods of the present disclosure further can include a communication interface. Such interface can include a variety of objects and devices that are adapted to transmit data arising from the interaction of the light source, light transmitting members, and light sensor. In one embodiment, a communication interface can be a continuous fiber optic cable that can communicate information related to the scattering of light through the material being monitored versus a continuous light transmission through the fiber optic cable. In other embodiments, the communication interface can comprise a wired or wireless communication network. Such network can gather data received by the light sensor that is indicative of the scattering of the light from the light source through the material being monitored via the light transmitting members. The light scattering data then can be transmitted by the communication interface for interpretation by a user. Transmission can occur in a wired or wireless format, including copper wire, magnetic or electric fields, acoustic fields, mud pulse, or other communication methodologies recognizable as useful by one of skill in the art with the benefit of the present disclosure. Exemplary fiber optic cables that can be used according to the present disclosure are described by Brown, George (2008/2009) “Downhole Temperatures from Optical Fiber”, Oilfield Review, 20(4), the disclosure of which is incorporated herein by reference.

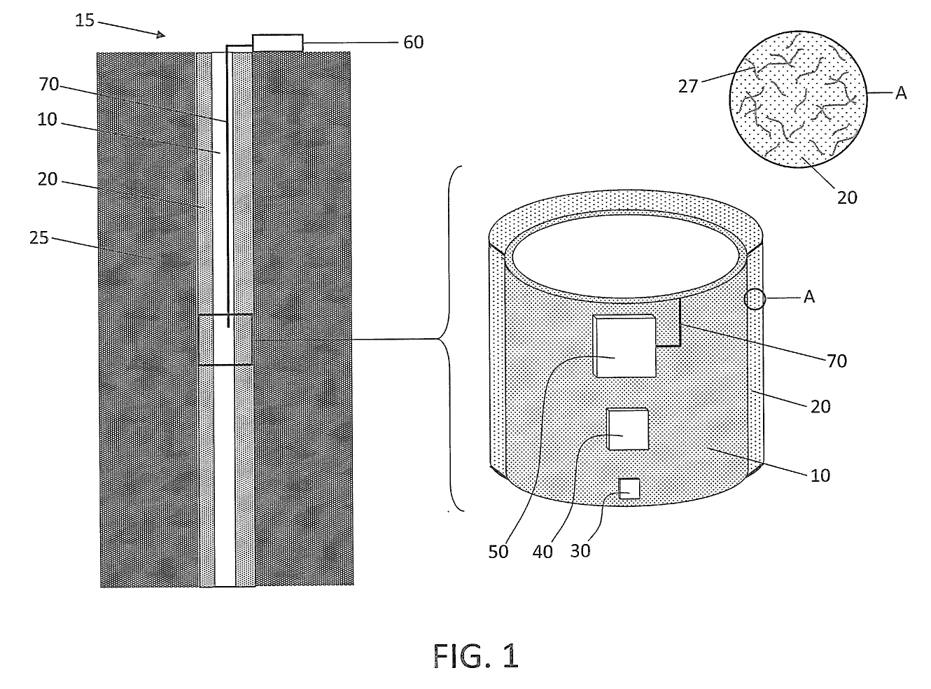

One embodiment illustrating implementation of a system according to the present disclosure in an oil well is shown in FIG. 1, which shows a section of a casing 10 in an oil well 15 that is reinforced with cement 20 between the casing and a formation 25. FIG. 1 also includes a magnified section of the casing 10 having a portion of the reinforcing cement 20 cut away to reveal components of the present system. Specifically, attached to the outside of the casing 10 is a light source 30, a sensor 40, and a communication interface 50. The cement 20 is infused with fibers 27 that function as the light transmitting member. A data processing unit 60 is shown positioned above ground. A data link 70 is shown as a wired component running from the communication interface within the well to the data processing unit above ground. The data link can be a part of a wired or wireless communication network.

As illustrated in FIG. 1, only a single light source, light sensor, and communication link are provided. Beneficially, the light source and light sensor can be co-located and separated in relation to the material being monitored. If desired, a plurality of light sensors can be used to detect the transmitted light from the light source through the material being monitored. In specific embodiments, a plurality of light sources can be used to provide light that is transmitted through the light transmitting members in the material being monitored to be detected by a light sensor. In other embodiments, a plurality of light sensors and a plurality of light sources can be used. In particular, the light sensors and light sources can be provided in a defined array. Such array can provide for a specific number of light sensors and/or light sources over a defined surface area of the material being monitored. Spacing of a light sensor and a light source in a system of the present disclosure can vary and be dependent upon the types of light source and light sensor used and the characteristic of the material to be monitored. For example, a light sensor can be located directly adjacent a light source. In other embodiments, a light source and a light sensor can be spaced apart a distance of about 0.25 m or more, about 0.5 m or more, about 1 m or more, about 5 m or more, or about 10 m or more. In certain embodiments, spacing can be about 0.25 m to about 40 m, about 0.3 m to about 30 m, or about 0.5 m to about 20 m. In embodiments related to oil wells, for example, sensing components can be placed on the outside of the well casing or the coupler that connects the casing strings. The sensing components can be placed at a variety of intervals around the casing. For example, the sensing components can be radially arranged at intervals ranging from about 10° to about 180°, about 20° to about 160°, about 30° to about 140°, about 45° to about 120°, or about 60° to about 90°. The radial spacing preferably is sufficient to provide the desired radial coverage. When spacing components circumferentially, the above intervals can be used in combination with linear spacing as well. For example, light sensors may be arranged at 90° intervals circumferentially and spaced linearly in a direction approximately perpendicular to the radial arrangement. One or both of a light source and a light sensor can be local to a cement bonding site (e.g., attached to an oil well casing and in contact with the cement). In other embodiments, one or both of the light source and light sensor can be located at a variety of depths (for example in an oil well) and/or a variety of distances away from an area where monitoring is desired. In specific embodiments, one or both of a light source and a light sensor can be located above or below a mass of material (e.g., cement) being monitored. Sensing components can include light sources that are sufficient to provide light for scattering and diffusion via the fibers.

In further embodiments, a system of the present disclosure can further comprise a data processing unit. Such unit can comprise any device adapted for implementing logic useful for interpretation of the light scattering and transmission data that is provided via the communication link. Data processing can include interpolation and/or extrapolation based on data points related to the extent or type of light scattering detected by the light sensor. Data processing can incorporate time-resolved and steady state dynamics. More particularly, optical tomographic reconstruction techniques can be used, including optical diffusion tomography—e.g., light diffusion fracture tomography (LDFT). Useful optical tomography techniques include time of flight (time domain) and phase coherence domain. Any like means for interpreting spatially dependent scattering properties of the transmitted light through the material to be monitored can be used. Some data processing may occur below ground as a component of the communications interface.

The light source for use according to the present disclosure can be modulated if desired. Non-limiting examples of light modulation include: on-off keying (OOK) with a duty cycle of about 1% to about 99%; pulse modulation with a low duty cycle (e.g., less than 1%, less than 0.5%, or less than 0.1%) and a pulse duration of about 300 picoseconds to about 1 microsecond, preferably about 1 nanosecond to about 10 nanoseconds; sinusoidal AM modulation with a plurality of frequencies of about 100 Hz to about 100 MHz, preferably about 1 MHz to about 50 MHz; and frequency modulated continuous wave (FMCW) with a chirp pattern in frequencies of about 100 Hz to about 100 MHz, preferably about 1 MHz to about 50 MHz. The received signal can be processed by, for example: direct detection; optically homodyne or heterodyne reception; IQ demodulation of the optical signal against a constant frequency RF source; or heterodyned against a replica FMCW chirp.

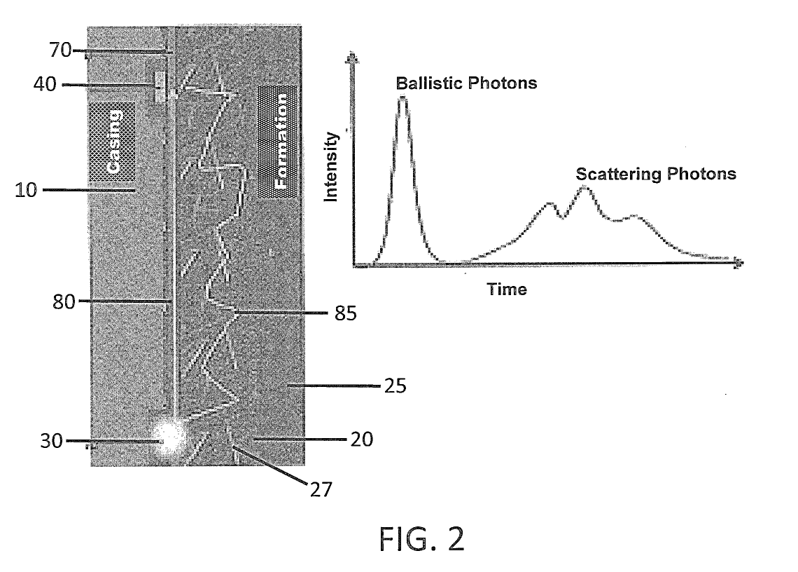

As an example, FIG. 2 shows a representation of a methodology that can be used according to the present disclosure for monitoring the nature of cement 20 positioned between casing 10 and a formation 25 in an oil well. As illustrated therein, a timing optical pulse can be created at a light source 30 (e.g., an LED) whereby a stream of ballistic photons 80 travel directly to the detector 40 through a fiber optic cable data link 70. The light source further causes a stream of scattering photons 85 to travel through the cement via the light transmitting fibers 27. The scattering photons arrive at a later time with a signature that indicates the optical path, which can change significantly in the presence of a characteristic change in the cement, such as a fracture, an air pocket in the cement, a mud cake, hydrocarbons, or other materials or objects that will interact with the light.

In use, the systems of the present disclosure can be implemented in a variety of settings. As such, the disclosure also provides for methods for monitoring a characteristic of a material. In certain embodiments, methods according to the disclosure can comprise positioning together specific elements of the disclosed system. Particularly, a mixture of the material to be monitored and a plurality of transmitting members can be positioned together with a light source, a light sensor, and a communication interface. The methods further can comprise receiving data related to light transmission through the plurality of light transmitting members and detection by the light sensor, said data being indicative of the characteristic of the material.

In an embodiment of the disclosure where the system is implemented in an oil well, the step of positioning, for example, can comprise filling at least a portion of an annular space between a casing and a formation wall in the well with a mixture of a cementitious material and a the plurality of light transmitting members. The light transmitting members can be pre-mixed with the cementitious material or can be mixed with the cementitious material on-site, including at the time of pumping the cementitious material into the well. The positioning step also can comprise locating one or both of the light source and the light sensor on the casing adjacent the mixture of the cementitious material and the plurality of light transmitting members. It can be particularly useful to attach the light source and/or light sensor to the casing prior to placement of the casing in the well. In embodiments where a fiber optic cable is used as a communication interface, the cable can be combined with the light source and light sensor as needed when the casing is positioned in the well. The step of receiving the data can comprise comparing transmission of light along a first pathway from the light source to the light sensor through the continuous fiber optic cable and along a second pathway from the light source to the light sensor through the mixture of the cementitious material and the plurality of light transmitting members. When a wireless or wired communication network is utilized, the necessary elements thereof can be positioned as necessary in relation to the material to be monitored.

In use, according to some embodiments of the present disclosure, data is received by the light sensor regarding the light from the light source that is transmitted through the material to be monitored via the light transmitting members. The data can be communicated to a user by the wired or wireless network. The user then can utilize the appropriate data processing equipment to analyze the data.

The system and methods of the invention can be implemented upon placement of the cementitious composition. Specifically, characteristics of the cement (e.g., defects and failures) can be sensed via the detection of the light from the light source that has been passed to the detector through the cement by the cement additives that enable waveguiding. Data received by the detectors can be transmitted to the surface for evaluation, such as by electrical wiring, wireless transmissions, and/or a continuous optical fiber.

### EXAMPLES

### Preparation of Glass-Fiber Reinforced Cement

Cem-FIL® alkali-resistant glass fiber strands from Owens Corning having an average length of about 12 mm (about 0.47 inches) were used for the following experiments. Approximately 5% to 20% by weight of cement glass fibers, based on the weight of the cement, were incorporated into a traditional Class H cement slurry having an approximate 0.40 to 0.50 water to cement (w/c) ratio, some including 0.2% (based on the weight of the cement) Diutan Gum as a viscosity modifying agent (VMA), and 0.33% (based on the weight of the cement) ADVA® 575 dispersant (a polycarboxylate-based ASTM C494 Type A and F and ASTM C1017 Type I plasticizer). The dispersant was used to help distribute the fibers and reduce clumping. Multiple formulations were tested, as given in the Table below (where all percentages are based on the weight of the cement). All formulations were made using a Waring blender per the American Petroleum Institute (API) Recommended Practice (RP) 10B protocol used to prepare cement slurries prior to glass fiber addition. The glass fibers in formulation 6 were added and blended during slurry preparation and thereby saw the high speed blending portion of API 10B protocol.

| | | | | | Glass |
|---|---|---|---|---|---|
| | w/c | | | % Glass | fiber |
| Formulation | ratio | % VMA | % ADVA ® 575 | fiber | addition |
| 1 | 0.40 | 0.20 | 0.33 | 5 | Slow |
| | | | | | blend |
| 2 | 0.40 | — | 0.33 | 5 | Slow |
| | | | | | blend |
| 3 | 0.40 | — | 0.33 | 10 | Hand mix |
| 4 | 0.40 | — | 0.33 | 15 | Hand mix |
| 5 | 0.40 | — | 0.33 | 20 | Hand mix |
| 6 | 0.50 | — | — | 20 | Fast |
| | | | | | blend- |
| | | | | | slurry |
| | | | | | prep |

After mixing the glass fibers into formulation 5 at a 20% loading (based on the weight of the cement), the material was placed into a petri dish and allowed to cure. The glass fibers appeared to wet out and distribute throughout the mix. Material from formulation 6 was placed into a plastic cylindrical canister having a width of approximately 3 inches (7.6 mm) and a height of approximately 8 inches (20.3 cm), closed shut, and allowed to hydrate or cure for at least 48 hours. After curing, disks having a thickness between approximately 0.5 inches (12.7 mm) and 0.75 inches (19 mm) were cut from the large cylinder. Some of the material was also placed into a large and small petri dish, in order to obtain disk-shaped samples. A general evaluation of the disks prepared from formulation 6 showed that light from an LED positioned on one side of the disk was recognizably transmitted through the disk to the opposing side.

### Characterization of Optical Fibers in Cement

A cement slurry was prepared, and optical fibers were placed into the wet slurry. The Class H Cement-based formulation having 0.40 w/c ratio and 0.2% VMA (based on the weight of the cement) was blended in a Waring blender per API 10B Protocol. The wet slurry was poured into a plastic cylindrical canister having a width of approximately 3 inches (7.6 mm) and a height of approximately 8 inches (20.3 cm); the bundle of optical fibers was introduced in a means to align the fibers with the cement flow, but also distribute the fibers to maintain cement integrity. Failure to spread the bundle of fibers was found to lead to a tendency to crack and break away from the optical fiber bundle. Once cured, the cement block was cut into disks having a thickness between approximately 0.5 inches (12.7 mm) and 0.75 inches (19 mm) using a standard wet cut tile saw equipped with a diamond blade. The resulting disks could then be held over an LED light source and illumination of the fibers would occur, thus making it a light transmitting cement-based material.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for monitoring a characteristic of a material, the system comprising:
a plurality of light transmitting members adapted for intermixture with the material;
a light source;
a light sensor; and
a communication interface.

2. The system according to claim 1, wherein the material is a cementitious material.

3. The system according to claim 1, wherein the light transmitting members comprise fibers.

4. The system according to claim 3, wherein the fibers are glass fibers or optical fibers.

5. The system according to claim 1, wherein the light transmitting members are light diffusive.

6. The system according to claim 1, wherein the light source comprises a light emitting diode or a laser.

7. The system according to claim 1, wherein the light source is adapted for modulation by one or more of: on-off keying (OOK) with a duty cycle of about 1% to about 99%; pulse modulation with a duty cycle of less than 1% and a pulse duration of about 300 picoseconds to about 1 microsecond; sinusoidal AM modulation with a plurality of frequencies of about 100 Hz to about 100 MHz; and frequency modulated continuous wave (FMCW) with a chirp pattern in frequencies of about 100 Hz to about 100 MHz.

8. The system according to claim 1, wherein the light sensor comprises a photodetector.

9. The system according to claim 1, wherein the communication interface comprises a continuous fiber optic cable, a wired communication network, or a wireless communication network.

10. The system according to claim 1, further comprising a data processing unit.

11. The system according to claim 10, wherein the data processing unit is adapted to process a received signal by one or more of: direct detection; optically homodyne or heterodyne reception; IQ demodulation of the signal against a constant frequency RF source; or heterodyned against a replica FMCW chirp.

12. The system according to claim 1, comprising a plurality of light sensors, a plurality or light sources, or both a plurality of light sensors and a plurality of light sources.

13. The system according to claim 1, wherein the light sensor and light source are co-located and separated.

14. The system according to claim 1, wherein the material comprises cement filled in at least a portion of an annular space between a casing and a formation wall in a well.

15. The system according to claim 14, wherein one or both of the light source and the light sensor are attached to the casing adjacent the cement.

16. The system according to claim 1, wherein at least a portion of the light transmitting members are surface functionalized or include a doping agent.

17. The system according to claim 16, wherein the doping agent enhances a light diffusion property of the light transmitting members.

18. The system according to claim 1, wherein at least a portion of the light transmitting members are hollow.

19. The system according to claim 25, wherein at least a portion of the hollow light transmitting members include a fluid component therein.

20. A method for monitoring a characteristic of a material, the method comprising:
positioning together:
a mixture of the material to be monitored and a plurality of light transmitting members;
a light source;
a light sensor; and
a communication interface; and
receiving data related to light transmission through the plurality of light transmitting members and detection by the light sensor, said data being indicative of the characteristic of the material to be monitored.

21. The method according to claim 20, wherein the material is a cementitious material.

22. The method according to claim 21, wherein said positioning comprises filling at least a portion of an annular space between a casing and a formation wall in a well with the mixture of the cementitious material and the plurality of light transmitting members.

23. The method according to claim 22, wherein said positioning further comprises locating one or both of the light source and the light sensor on the casing adjacent the mixture of the cementitious material and the plurality of light transmitting members.

24. The method according to claim 22, wherein a plurality of light sources and a plurality of light sensors are co-located and separated on the casing.

25. The method according to claim 20, wherein the light source and the light sensor are in direct communication via a continuous fiber optic cable.

26. The method according to claim 25, wherein said receiving step comprises comparing transmission of light along a first pathway from the light source to the light sensor through the continuous fiber optic cable and along a second pathway from the light source to the light sensor through the mixture of the cementitious material and the plurality of light transmitting members.

27. The method according to claim 20, wherein the light transmitting members comprise fibers.

28. The method according to claim 27, wherein the fibers are glass fibers or optical fibers.

29. The method according to claim 20, wherein the light transmitting members are light diffusive.

30. The method according to claim 20, wherein the light source comprises a light emitting diode or a laser.

31. The method according to claim 20, wherein the light source is adapted for modulation by one or more of: on-off keying (OOK) with a duty cycle of about 1% to about 99%; pulse modulation with a duty cycle of less than 1% and a pulse duration of about 300 picoseconds to about 1 microsecond; sinusoidal AM modulation with a plurality of frequencies of about 100 Hz to about 100 MHz; and frequency modulated continuous wave (FMCW) with a chirp pattern in frequencies of about 100 Hz to about 100 MHz.

32. The method according to claim 20, wherein the light sensor comprises a photodetector.

33. The method according to claim 20, wherein the step of receiving data comprises processing the date related to light transmission by one or more of: direct detection; optically homodyne or heterodyne reception; IQ demodulation of the signal against a constant frequency RF source; or heterodyning against a replica FMCW chirp.

34. The method according to claim 20, wherein the communication interface comprises a wired or wireless communication network.
